(19) United States
(12) Patent Application Publication
(10) Pub. No.: US 2017/0317991 A1
(43) Pub. Date: Nov. 2, 2017

(54) OFFLOADING STORAGE ENCRYPTION OPERATIONS

(71) Applicant: NetApp, Inc., Sunnyvale, CA (US)

(72) Inventor: Christopher Lee Lionetti, Duvall, WA (US)

(21) Appl. No.: 15/141,891

(22) Filed: Apr. 29, 2016

(51) Int. Cl. H04L 29/06; G06F 12/14; H04L 9/08

(52) U.S. Cl. CPC H04L 63/0471; H04L 63/0853; H04L 63/0823; G06F 12/1408; H04L 9/0894; H04L 63/061; G06F 2212/1052

(57) ABSTRACT

To decrease a load on a network and a storage system, encryption operations can be offloaded to a server locally connected to the storage system. The server receives requests to perform encryption operations, such as LUN encryption or file encryption, for a host. The server obtains an encryption key unique to the host and performs the encryption operation using the encryption key. The server then notifies the host that an encrypted LUN or encrypted file is available for use. The host is able to utilize the encrypted data because the encryption was performed with the host's unique key. Since the server is locally connected to the storage system, offloading encryption requests to the server reduces the load on a network by reducing the amount of traffic transmitted between a host and the storage system.

### BACKGROUND

The disclosure generally relates to the field of computer systems, and more particularly to offloading encryption operations for devices connected to a storage system.

A device may utilize an encrypted disk drive or storage area, such as a logical unit number (LUN), to increase security and protect stored data. The device encrypts the drive or storage area using an encryption key that is unique to the device. The encryption key may be generated by an operating system or trusted platform module (TPM) chip on the device. Initial encryption of a storage area or encrypting large files to be stored in an encrypted storage area can tax resources of the device such as the processor and storage throughput. Additionally, if the device utilizes or boots from a storage area in network attached storage, the encryption operations can consume a large amount of network bandwidth as unencrypted data is read from the storage area, encrypted, and written back to the storage area.

### BRIEF DESCRIPTION OF THE DRAWINGS

Aspects of the disclosure may be better understood by referencing the accompanying drawings.

FIG. 1 depicts an example storage system with an encryption server for performing LUN encryption.

FIG. 2 depicts a flow diagram of example operations for offloading LUN encryption of a LUN.

FIG. 3 depicts an example storage system with an encryption server for offloading encryption of a file to be stored on an encrypted LUN.

FIG. 4 depicts a flow chart with example operations for offloading storage of a file into an encrypted load.

FIG. 5 depicts a flow diagram with example operations for managing offloaded encryption operations to control load of a storage system.

FIG. 6 depicts an example computer system with an offload encrypter.

### DESCRIPTION

The description that follows includes example systems, methods, techniques, and program flows that embody aspects of the disclosure. However, it is understood that this disclosure may be practiced without these specific details. For instance, this disclosure refers to LUNs in a storage system in illustrative examples. But aspects of this disclosure can be applied to other types of storage volumes such as hard disks, virtual machine disks (VMDK), all flash arrays, etc. In other instances, well-known instruction instances, protocols, structures and techniques have not been shown in detail in order not to obfuscate the description.

### Terminology

This description refers to a LUN to describe a storage area on a larger storage volume. Similar to a partition of a disk drive, a LUN is a logical unit of storage that is part of a larger storage volume. Since the logical unit of storage is identified by its assigned number, the term LUN is often used to refer to a particular logical unit of storage. A device can use and map a LUN like a disk drive even if the LUN spans multiple physical disks in a disk array or only occupies a portion of a single disk. A LUN can be accessed through interfaces such as fiber channel, small computer system interface (SCSI), Internet SCSI (iSCSI), and other similar interfaces.

This description uses the term logical block addresses (“LBAs”) to describe a logical abstraction of physical locations of data within a LUN or storage area. LBAs are used to specify the location of blocks of data within a LUN. The LBA can be mapped to a physical location by a storage driver or other component of a storage device. The size of a block addressed by an LBA can vary depending on a file system or addressing scheme used within a storage system. In some instances, LBAs may be grouped into contiguous ranges referred to as extents. Some file systems or storage systems may address data at the extent level. As used herein, providing LBAs or a range of LBAs may also be considered as providing an extent or extent list. For example, an extent may comprise 10 LBAs, so providing an extent is similar to providing an LBA range comprising 10 LBAs.

This description uses the term “file” to refer to a discrete collection of data in a LUN. A file may also be referred to as a data unit, data object, etc.

Overview

Hosts that utilize encrypted LUNs can increase a load on a network and a storage system with the overhead generated by the encryption process. The load may be reduced by offloading encryption to a server locally connected to the storage system. The server receives requests to perform encryption operations such as LUN encryption or file encryption. The requests may be received directly from a host or redirected to the server by a storage controller in the storage system. The server obtains an encryption key unique to the host and performs the encryption operation using the encryption key. The server then notifies the host that an encrypted LUN or encrypted file is available for use. The host is able to utilize the encrypted LUN or file because the encryption was performed with the host's unique key. Since the server is locally connected to the storage system, offloading encryption requests to the server reduces the load on a network by reducing the amount of traffic transmitted between a host and the storage system. Additionally, offloading increases data security because unencrypted data is not transmitted across a potentially untrusted network but, rather, is transmitted locally between the server and the storage system.

Example Illustrations

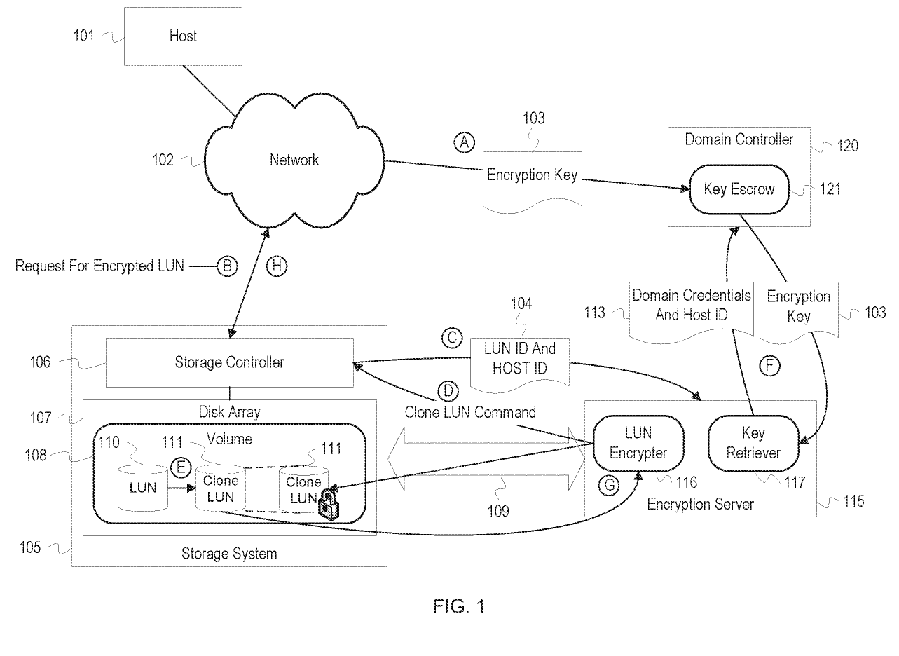

FIG. 1 is annotated with a series of letters A-H. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 1 depicts an example storage system with an encryption server for performing LUN encryption. FIG. 1 depicts a host 101, a storage system 105, an encryption server 115, and a domain controller 120. The storage system 105 includes a storage controller 106 and a disk array 107 that includes a volume 108. The encryption server 115 includes a LUN encrypter 116 and a key retriever 117. The host 101, the storage system 105, the encryption server 115, and the domain controller 120 communicate through a network 102. The encryption server 115 and the storage system 105 communicate through a high-speed interconnect 109. The high-speed interconnect 109 may be any type of high-throughput connection such as an InfiniBand or fiber connection. Alternatively, the encryption server 115 and the storage system 105 can communicate through any other type of communications media. In some implementations, the storage system 105 and the encryption server 115 share an enclosure and are connected through a backplane. In other implementations, the storage system 105 and the encryption server 115 may communicate through a local or trusted network.

The storage system 105 may be a type of network attached storage (NAS) and may be part of a storage area network (SAN) that includes multiple storage systems. The disk array 107 is an array of storage devices such as hard drive disks, solid state drives, flash memory, etc. The volume 108 may span one or more of the storage devices in the disk array 107. The storage system 105 may include one or more storage controllers and one or more disk arrays in addition to the storage controller 106 and the disk array 107. Additionally, the disk array 107 may include one or more volumes in addition to the volume 108.

The host 101 may be a server that hosts resources such as applications, virtual machines, database management systems, etc. The host 101 reads and writes data from the storage system 105 by sending commands to the storage controller 106 through the network 102. The network 102 may be a local area network or a wide area network such as the Internet. The host 101 may communicate with the storage controller 106 via various protocols such as iSCSI, SCSI, Hypertext Transfer Protocol (HTTP) REST protocols, etc. The host 101 may store data in a LUN of the storage system 105 or may boot from a LUN stored on the storage system 105 using various hardware and software protocols such as a network interface card (NIC) that is enabled with iSCSI or a Pre-Boot Execution Environment (PXE).

At stage A, the host 101 joins a domain controlled by the domain controller 120 and provides an encryption key 103. The domain is a network that requires connected entities to be registered with a central component such as the domain controller 120. The domain controller 120 enforces security and permissions for entities in the domain and may be used to manage and change settings for connected entities. The host 101 may join the domain by providing login credentials (not depicted) to the domain controller 120. The domain controller 120 authenticates the credentials and joins the host 101 to the domain. In FIG. 1, the domain controller 120 requests that connected entities publish an encryption key to the domain controller 120 or an active directory of the domain controller 120. As a result, when the host 101 joins the domain, the host 101 sends the encryption key 103 to the domain controller 120. The encryption key 103 is a private key that is unique to the host 101 and is used to encrypt a drive or storage area associated with the host 101. The encryption key 103 may be generated in software by an operating system or process of the host 101 or may be generated using hardware on the host 101 such as a TPM chip. After receiving the encryption key 103, the domain controller 120 stores the encryption key 103 in key escrow 121 along with an identifier for the host 101. For subsequent domain logins of the host 101, the domain controller 120 may first search the key escrow 121 with the identifier for the host 101 to determine if an encryption key is present before again requesting an encryption key.

At stage B, the host 101 sends a request for an encrypted LUN to the storage controller 106. The host 101 may send the request in response to a variety of conditions or inputs. For example, the host 101 may be configured to request a LUN upon starting up a first time, or a hypervisor on the host 101 may initiate the request in response to a request for an additional virtual machine image. In some implementations, the request may originate from a third party device such as an administrator console being used to configure the host 101. The host 101 identifies the LUN 110 in the request as the LUN to be encrypted. A LUN may be identified by a storage path that may include a disk identifier, controller identifier, SCSI target identifier, volume identifier, etc.

At stage C, the storage controller 106 sends an identifier (“ID”) for the host 101 and the LUN 110 (“LUN ID and host ID 104”) to the encryption server 115. The storage controller 106 is configured to offload requests that involve encryption to the encryption server 115. The storage controller 106 may determine whether a request involves encryption by analyzing parameters of the request or based on a configuration of the volume 108. For example, the storage controller 106 may determine that the volume 108 is configured to host encrypted LUNs and redirect requests targeting the volume 108. In some implementations, the encryption server 115 may receive the LUN ID and host ID 104 directly from the host 101. The host 101 may send the LUN ID and host ID 104 through an application program interface (API) using a script or a remote procedure call.

At stage D, the LUN encrypter 116 requests that the storage controller 106 create a clone LUN 111 of the LUN 110. The LUN 110 may be a gold or master image for a virtual machine or operating system that is maintained for configuring new hosts added to the network 102. Additionally, in some instances, the host 101 may have been using the LUN 110 for unencrypted data storage and may now request to encrypt the stored data. As a result, the LUN encrypter 116 requests that a clone of the LUN 110 be created to avoid risking data loss during the encryption process. The request instructs the storage controller 106 to map the clone LUN 111 to the encryption server 115 so that the encryption server 115 may access the clone LUN 111. In some implementations, the LUN 110 may not be cloned prior to encryption, rather the data may be read, encrypted, and written back to the LUN 110.

At stage E, the storage controller 106 creates the clone LUN 111 from the LUN 110. The storage controller 106 allocates storage space for the clone LUN 111 within the volume 108 and creates an identifier for the clone LUN 111 that references the storage space. The clone LUN 111 is created on the volume 108 in FIG. 1 but may be created on other volumes as determined by the host 101 or a configuration of the storage system 105, such as designation of a specific disk array or volume for use by the host 101. In FIG. 1, the clone LUN 111 as first created by the storage controller 106 is depicted with dashed lines since the clone LUN 111 merely includes pointers to the data in the LUN 110 rather than containing a copy of the data. In some instances, such as if the clone LUN 111 is being created in a different storage system, the storage controller 106 may perform a clone split operation which actually copies the data of the LUN 110 to the clone LUN 111.

At stage F, the key retriever 117 retrieves the encryption key 103 from the domain controller 120. The key retriever 117 sends domain credentials and the host ID 113 to retrieve the encryption key 103 from the key escrow 121. The domain credentials may be administrator credentials or may be credentials for an account that has permission to access the key escrow 121. The domain controller 120 authenticates the credentials and then searches the key escrow 121 using the host ID to retrieve the encryption key 103. The domain controller 120 then provides the encryption key 103 to the key retriever 117.

At stage G, the LUN encrypter 116 encrypts the clone LUN 111 using the encryption key 103. The LUN encrypter 116 sends a series of read requests (not depicted) to the storage controller 106 to read the data from the clone LUN 111. As the LUN encrypter 116 receives the data, the LUN encrypter 116 encrypts the data and then sends the encrypted data with write commands (not depicted) to the storage controller 106. The storage controller 106 then writes the encrypted data to the same location in the clone LUN 111 from which it was read. The encrypted data is written to the same location as some encryption techniques, such as cipher block chaining, create interdependencies among the encrypted blocks. For example, an unencrypted block may be logically or'ed with a previously encrypted block prior to encryption. As a result, decryption of the encrypt blocks may require that the order and location of the encrypted blocks remain unchanged from the original unencrypted location. Additionally, some encryption techniques may utilize the LBA of a block, a sector identifier, or other location information as an initialization vector or other key during the encryption process.

The LUN encrypter 116 is configured to use an encryption technique that is also implemented at the host 101. For example, the LUN encrypter 116 may use proprietary disk encryption protocols such as Microsoft BitLocker, TrueCrypt, McAfee Endpoint Encryption, etc. The LUN encrypter 116 may use the Advanced Encryption Standard (AES) with an Rivest Shamir Adleman (RSA) key and cipher block chaining (CBC) or a ciphertext stealing technique such as XTS. Additionally, the LUN encrypter 116 may employ one or more diffusers with varying directionality such as the Elephant Diffuser. The LUN encrypter 116 uses the same technique as the host 101 so that the host 101 will be able to decrypt the data encrypted by the LUN encrypter 116 as well as add additional encrypted data to the clone LUN 111 as the clone LUN 111 is used by the host 101. In some implementations, after successfully encrypting the clone LUN 111, the encryption server 115 may send a command to delete the LUN 110 in order to remove the unencrypted data from the storage system 105.

At stage H, the encryption server 115 sends a command to the storage controller 106 to re-map the clone LUN 111 to the host 101. The encryption server 115 or the storage controller 106 may also send a message or command to the host 101 to notify the host 101 that the clone LUN 111 has been encrypted. The host 101 may perform various operations such as mapping the clone LUN 111 as a network drive or configuring a Host Bus Adapter (HBA) to boot from the clone LUN 111.

In some implementations, the encryption server 115 requests the encryption key 103 directly from the host 101 instead of retrieving the encryption key 103 from the key escrow 121. In such implementations, the encryption server 115 may be configured as a trusted resource on the network 102 or may send credentials or a security token to the host 101 to identify itself as a trusted resource. Additionally, some implementations may not include a domain managed by the domain controller 120. In such implementations, the key escrow 121 may be maintained by or associated with a different authentication system such as a single sign on system, and the key retriever 117 may log in and request the key from the single sign on system.

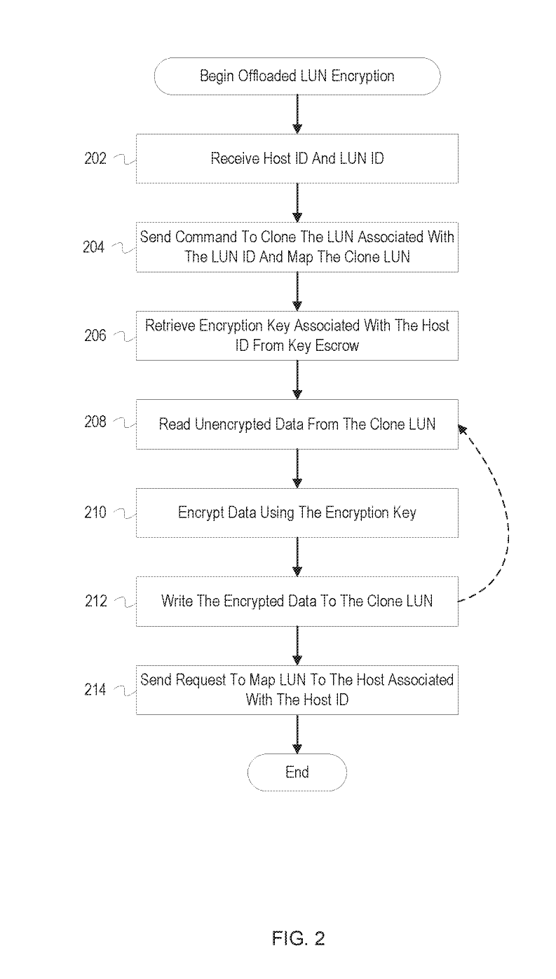

FIG. 2 depicts a flow diagram of example operations for offloading LUN encryption of a LUN. The operations described in FIG. 2 are described as being performed by an encryption server, such as the encryption server 115 depicted in FIG. 1 but may be performed by a similar component or device in communication with or located within a storage system.

At block 202, an encryption server (“server”) receives a host ID and a LUN ID. The host ID identifies a host that is requesting an encrypted LUN be assigned to it, and the LUN ID identifies an unencrypted LUN that is to be encrypted. The server may receive the IDs from a storage controller or from the host. For example, the storage controller may be configured to forward encryption requests to the server, or the host may be configured to send encryption requests to the server through an API.

At block 204, the server sends a command to the storage controller to clone the LUN associated with the LUN ID and map the clone LUN to the server. A clone LUN may be created so a LUN that is a gold or master image may be reused or may be created to reduce the risk of losing data during the encryption process. Additionally, a clone LUN may be created if the LUN to be encrypted is located on a volume not accessible by the host or if the storage system is configured to host encrypted LUNs on a particular volume or disk array. In these instances, the server causes the clone LUN to be created in the particular location or volume accessible by the host. In some implementations, the server may not create a clone LUN but will encrypt the LUN in place on the storage system.

At block 206, the server retrieves an encryption key associated with the host ID from key escrow. The server may use credentials to login to an authentication server or domain controller that maintains the key escrow to retrieve the encryption key associated with the host ID. The server may also retrieve other information from the key escrow such as a type of encryption technique used by the host. For example, the server may determine that the host uses BitLocker encryption or may determine that the host uses 256 or 128 bit encryption. In some implementations, the server is configured to apply a uniform encryption technique for each host in the domain or network and may not retrieve additional information related to encryption technique.

The blocks 208, 210, and 212 describe operations for reading, encrypting, and writing data in the clone LUN. These operations may be performed sequentially, atomically, in parallel, or partially in parallel. As indicated by the dashed arrow from block 212 to block 208, these operations may be repeated as more data is read from the clone LUN, encrypted, and then written back to the clone LUN in encrypted form.

At block 208, the server reads unencrypted data from the clone LUN. The server may read the data in chunks that correspond to the amount of data that is encrypted at a time, such as a block or extent. As a result, the server may send a series of read requests to the storage controller until all data has been read from the clone LUN. In some implementations, the server may read the entire clone LUN into a buffer or memory before beginning encryption.

At block 210, the server encrypts the read data using the encryption key. The server uses the host's encryption key and encryption technique to encrypt the read data. The server may encrypt the data in various sized blocks, chunks, or extents in accordance the configured encryption technique. Since the encryption process can create interdependencies between blocks of data, the server may begin encrypting the clone LUN at the beginning of the LUN or at LBA 0. The server may then continue encrypting the blocks sequentially. In some implementations, interdependencies between blocks is maintained based on sectors of data, so the server may encrypt different sectors of the clone LUN in parallel.

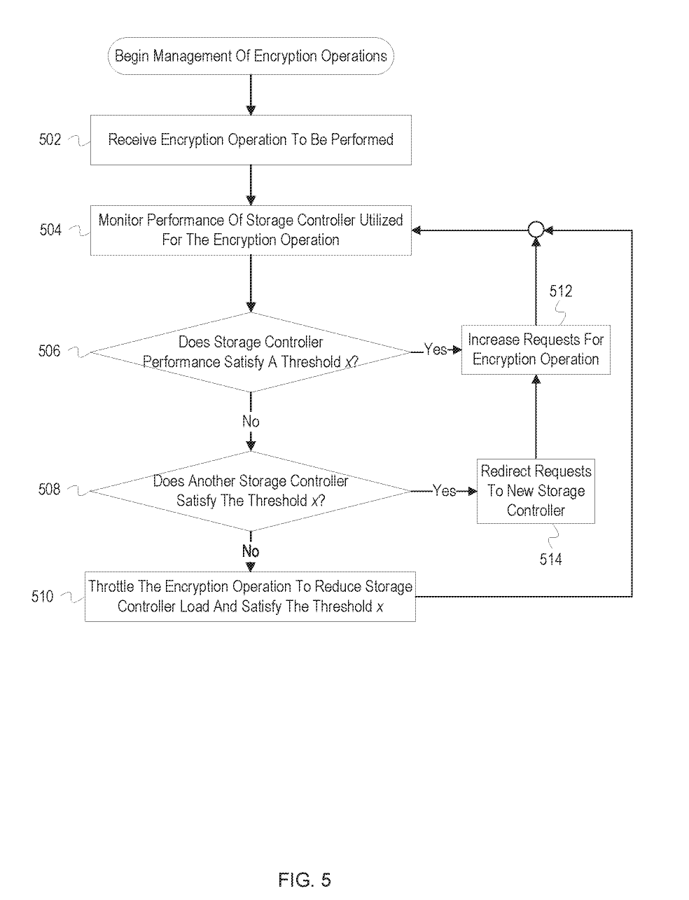

At block 212, the server writes the encrypted data to the clone LUN. The server sends the encrypted data along with a write command to the storage controller to write the encrypted data to the same LBA from which the unencrypted data was read. The server may write the encrypted data as completed throughout the encryption process, so a series of write commands may be sent to the storage controller. The number of writes issued to the storage controller may be throttled or managed based on the load of the storage controller as described in more detail in FIG. 5.

At block 214, the server requests that the encrypted clone LUN be mapped to the host. Since the clone LUN was mapped to the server at block 204, the server instructs the storage controller to re-map the encrypted clone LUN to the host. The storage controller may add the host to an access list for the encrypted clone LUN. The server may then send an ID for the encrypted LUN to the host thereby notifying the host that the encrypted LUN is available for use. The host may then map the LUN to itself or configure a NIC card or other device to boot from the encrypted LUN.

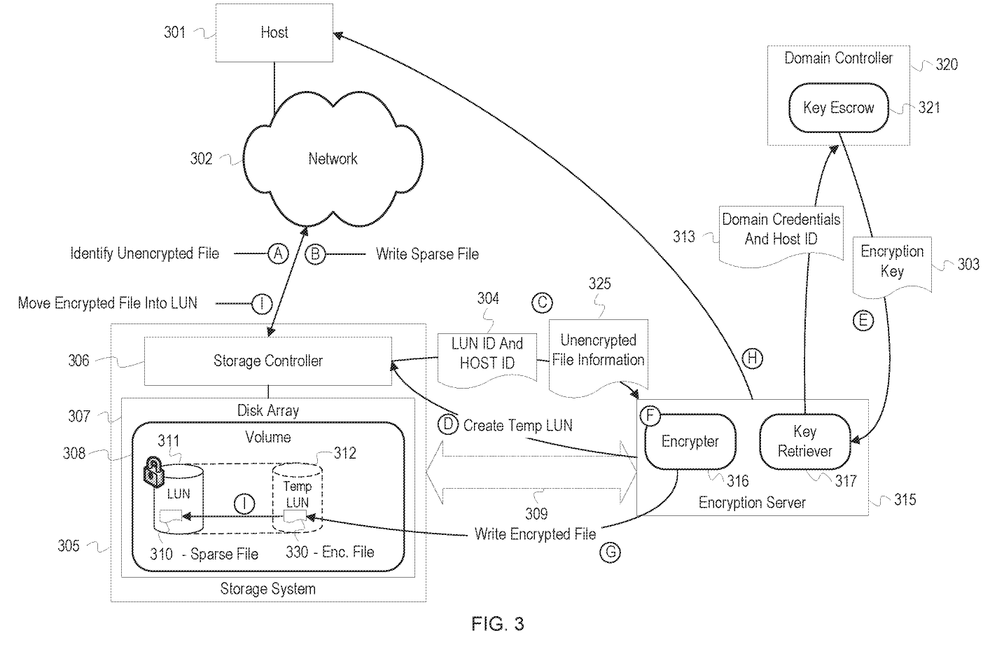

FIG. 3 is annotated with a series of letters A-I. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 3 depicts an example storage system with an encryption server for offloading encryption of a file to be stored on an encrypted LUN. FIG. 3 depicts a host 301, a storage system 305, an encryption server 315, and a domain controller 320. The storage system 305 includes a storage controller 306 and a disk array 307 that includes a volume 308. The encryption server 315 includes an encrypter 316 and a key retriever 317. The host 301, the storage system 305, the encryption server 315, and the domain controller 320 communicate through a network 302. The encryption server 315 and the storage system 305 may also communicate through a high-speed interconnect 309.

At stage A, the host 301 identifies an unencrypted file (not depicted) to be stored on a LUN 311. The LUN 311 is an encrypted LUN assigned to the host 301. Typically, the host 301 may read or receive an unencrypted file from a storage system, encrypt the file using its resources, and store the encrypted file in the LUN 311. However, in FIG. 3 the host 301 offloads storage of the unencrypted file to the encryption server 315. The host 301 may offload the encryption operation if the unencrypted file is a large file that may take significant time, resources, and network bandwidth for the host 301 to encrypt and store. Additionally, the host 301 may offload storage operations if the host 301 is currently experiencing a high load, regardless of the size of the unencrypted file. To facilitate offloading file storage, the host 301 sends information to the storage controller 306 identifying the unencrypted file to be encrypted and moved to the LUN 311. The information may include a location (e.g. file path, LUN identifier, block address or offset) and file metadata such as name, size, or type. In some implementations, the host 301 may send the information directly to the encryption server 315. The unencrypted file may be located on the storage system 305 or may be located on a different storage system, disk array, or volume.

At stage B, the host 301 writes a sparse file 310 to the LUN 311. The sparse file 310 is a file that does not include data but is made up of empty blocks in the LUN 311. The number of blocks “occupied” by the sparse file 310 can be equal to the number of blocks needed to store the unencrypted file. The host 301 writes the sparse file 310 to the LUN 311 to determine the LBAs at which the unencrypted file will be stored once encrypted. After writing the sparse file 310, the host 301 sends a command to the storage controller 306 to lock the LBAs for the sparse file 310 to prevent routine operations of the storage system 305, such as defragmentation or deduplication, from affecting the LBAs of the sparse file 310. The storage controller 306 may lock the LBAs by adding the LBAs to a list of addresses that are excluded from routine operations or setting a bit in the blocks (or extents or sectors comprising the blocks) to indicate that the LBAs are excluded.

At stage C, the storage controller 306 sends an identifier (“ID”) for the host 301 and the LUN 310 (“LUN ID and host ID 304”) to the encryption server 315. Also at stage C, the storage controller 306 sends information related to the unencrypted file (“unencrypted file information 325”) to the encryption server 315. The unencrypted file information 325 indicates the location of the unencrypted file and the LBAs of the sparse file 310. In some implementations, the host 301 may send the LUN ID and host ID 304 and the unencrypted file information 325 to the encryption server 315 without passing the data through the storage controller 306. The host 301 may send the data using a script or process for offloading encrypted file storage and transmit the data through the network 302. The host 301 may send the data using various communication protocols such as HTTP or through an API of the encryption server 315.

At stage D, the encryption server 315 sends a request to the storage controller 306 to create a temporary clone LUN 312 of the LUN 311. The LUN 311 is mapped for use by the host 101. As a result, the encryption server 315 is unable to access the LUN 311 or may corrupt or damage the LUN 311 if simultaneous access with the host 301 is attempted. To avoid this risk, encryption server 315 uses the temporary clone LUN 312. The storage controller 106 maps the temporary clone LUN 312 to the encryption server 315.

At stage E, the key retriever 317 retrieves the encryption key 303 from the domain controller 320. The encryption key 303 is retrieved in a manner similar to that of the encryption key 103 as depicted at stage F of FIG. 1.

At stage F, the LUN encrypter 316 reads from the unencrypted file identified in the unencrypted file information 325. The LUN encrypter 316 determines the location of the file as indicated in the unencrypted file information 325 and sends a read request (not depicted) to a storage system or other component that is hosting the file. For example, the LUN encrypter 316 may determine that the file is being hosted by a web server that allows access to the file through a uniform resource locator (URL). The LUN encrypter 316 may download the file using HTTP and store the file in memory of the encryption server 315 during the encryption process. In some implementations, the unencrypted file may be located in memory or other storage of the host 301. In such implementations, the encryption server 315 may retrieve the unencrypted file from the host 301 using various communication protocols such as HTTP REST, file transfer protocol (FTP), etc. The LUN encrypter 316 may read the unencrypted file in increments such as blocks or a number of bytes at a time in order to prevent overloading a system hosting the file with a read request for the entire file.

At stage G, the LUN encrypter 316 encrypts the unencrypted file data and writes an encrypted file 330 to the temporary clone LUN 312 at the location of the sparse file 310. The LUN encrypter 316 encrypts the unencrypted file using the encryption key 303 and an encryption technique used by the host 301. For example, the LUN encrypter 316 may determine that the host 301 uses TrueCrypt and use TrueCrypt along with the encryption key 303 to create the encrypted file 330. After encrypting the unencrypted file, the LUN encrypter 316 sends a series of write requests to the storage controller 306 to write the encrypted file 330 to the temporary clone LUN 312. The encrypted file 330 is written to a location in the temporary clone LUN 312 that corresponds to the location of the sparse file 310 in the LUN 311. Each block of the encrypted file 330 is written to an LBA of the temporary clone LUN 312 which corresponds to one of the LBAs of the sparse file 310 received at stage C. For example, if the sparse file 310 begins at block 50 of the LUN 311, the LUN encrypter 316 begins writing the encrypted file 330 at block 50 of the temporary clone LUN 312. Depending on the encryption technique used, the LUN encrypter 316 may read encrypted data from the LBA immediately preceding the first block of the sparse file 310. For example, if CBC is used, the LUN encrypter 316 may read the encrypted block of data so that the encrypted data may be OR'ed or XOR'ed with the first block of the encrypted file 330.

At stage H, the encryption server 315 notifies the host 301 that the encrypted file 330 is available in the temporary clone LUN 312. The encryption server 315 may send an ID for the temporary clone LUN 312 to the host 301. Since the encrypted file 330 was written to the same LBAs as the sparse file 310, the host 301 can use the LBAs of the sparse file 310 to read the encrypted file 330 from the temporary clone LUN 312. The encryption server 315 may also instruct the storage controller 306 to map the temporary clone LUN 312 to the host 301 to allow access by the host 301. Alternatively, the encryption server 315 may initiate an offload data transfer (sometimes referred to as ODX) and may send a token representing the encrypted file 330 to the host 301.

At stage I, the host 301 sends a command to the storage controller 306 to move the encrypted file 330 from the temporary clone LUN 312 to the LUN 311. The encrypted file 330 can be moved into and accessed through the LUN 311 because the encrypted file 330 was written to the same LBAs as the sparse file 310. To move the encrypted file 330, the host 301 may send a sub-LUN clone command which allows for the cloning of one or more files within a LUN. In FIG. 3, the host 301 sends the sub-LUN clone command to instruct the storage controller 306 to clone the encrypted file 330 at the location of the sparse file 310. The storage controller 306 performs the sub-LUN clone by updating pointers of the sparse file 310 to point to the physical addresses containing the encrypted file 330. Alternatively, if using ODX, the host 301 sends a write command along with the token representing the encrypted file 330 to cause the storage controller 306 to move the encrypted file 330 from the temporary clone LUN 312 to the LUN 311. Unlike the sub-LUN clone command, ODX may cause an actual copy of the file to be created; however, the encrypted file 330 is still not read from the storage system 305 by the host 301 and then written back to the storage system 305 to the LUN 311, as the copying of the encrypted file 330 occurs locally.

After the encrypted file 330 is moved from the temporary clone LUN 312 to the LUN 311, the host 301 or the encryption server 315 may send a command to release or remove the temporary clone LUN 312 since the temporary clone LUN 312 is no longer being used by the encryption server 315. In some implementations, the host 301 may notify the encryption server 315 that transfer of the encrypted file 330 is complete and allow the encryption server 315 to manage releasing the temporary clone LUN 312. In some implementations, the encryption server 315 may maintain a list of existing temporary clone LUNs and may send a command to have them removed after a period of time or as new clones of a LUN are created.

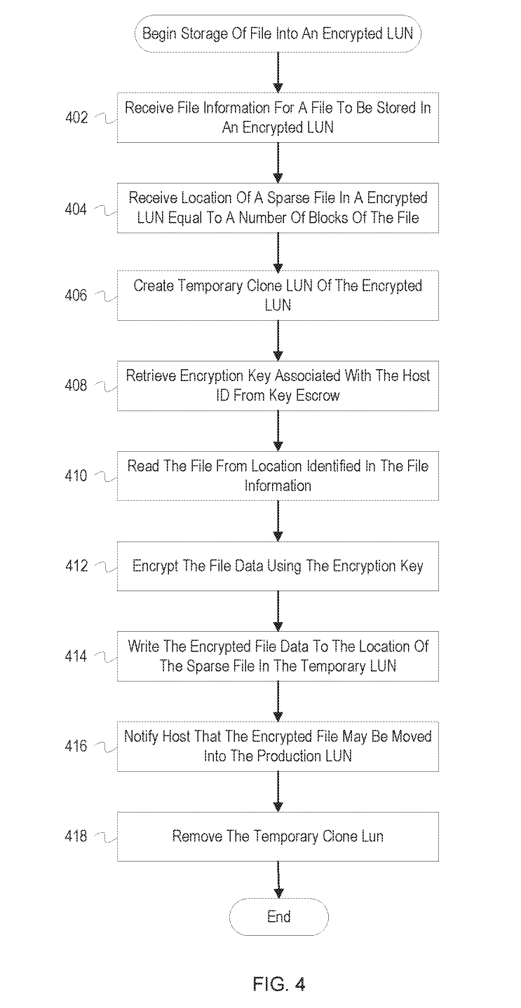

FIG. 4 depicts a flow chart with example operations for offloading storage of a file into an encrypted LUN. The operations described in FIG. 4 are described as being performed by an encryption server, such as the encryption server 315 depicted in FIG. 3 but may be performed by a similar component or device in communication with or located within a storage system.

At block 402, an encryption server (“server”) receives file information for a file to be stored in an encrypted LUN. The file information includes identification information for the file and a number of blocks needed to store the file. Alternatively, the server may receive the size of the file and determine the number of blocks needed to store the file based on a block size of a storage system hosting the encrypted LUN. The server may receive the file information from a host or from a storage controller that has redirected a request to store the file.

At block 404, the server receives a location of a sparse file on the encrypted LUN equal to a number of blocks needed to store the file. Since the sparse file is the same number of blocks as the file to be encrypted and stored, the sparse file can be used to determine the eventual logical block address location of the encrypted file. Additionally, the location of the sparse file can be locked to prevent the location from being defragmented or otherwise affected by routine storage system operations. The host may write the sparse file by creating a file with metadata that indicates the block size of the file and sending the created file to the storage system with a write command. The host writes the sparse file in instances where the LUN is in use by the host and therefore cannot be accessed by the server. After writing the sparse file, the host notifies the server of the location of the sparse file. The host may send the server a LBA range or extent list for the location of the sparse file. In implementations where the server can access the encrypted LUN, the server may create and write the sparse file.

At block 406, the server creates a temporary clone LUN of the encrypted LUN. The server sends a command to the storage controller to create a clone LUN that is mapped to the server in instances where the encrypted LUN is not accessible by the server. The server can then perform operations on the clone LUN without affecting use of the encrypted LUN.

At block 408, the server retrieves an encryption key associated with the host ID from key escrow. The server retrieves the encryption key in a manner similar to that described at block 206 of FIG. 2.

At block 410, the server reads the file from the location identified in the file information, and at block 412, the server encrypts the file data using the encryption key. The server encrypts the file in accordance with a configured encryption technique or in accordance with an encryption technique indicated for the host in the key escrow. The server encrypts the data according to the eventual location of the encrypted data in the encrypted LUN, i.e. the location of the sparse file. This may involve reading encrypted data from the LBA preceding the sparse file for use in the encryption process or using an LBA or sector location as an initialization vector in the encryption process.

At block 414, the server writes the encrypted file data to the location of the sparse file in the temporary clone LUN. For example, if the sparse file in the encrypted LUN begins at block 10, the server writes the encrypted file data to the temporary clone LUN beginning at block 10.

At block 416, the server notifies the host that the encrypted file may be moved from the temporary clone LUN into the encrypted LUN. The host may move the file using the offloaded data transfers process. Alternatively, the host may request that the storage controller remap the LBAs of the sparse file to point to the physical location of the encrypted file or remap pointers stored in an index node (inode) of the sparse file to point to the encrypted file data.

At block 418, the server causes the temporary clone LUN to be removed or released. Once the encrypted file data has been moved into the encrypted LUN, the temporary clone LUN may be deleted or freed up. The server may send a command to the storage controller indicating that the temporary clone LUN may be removed. The server may send the command to release the temporary clone LUN after receiving an indication from the host that the encrypted file was moved or after a period of time has elapsed. After the temporary clone LUN is removed, the process ends.

The operations described above in FIG. 4 may be repeated for additional hosts connected to a storage system. For example, a file to be encrypted may be a service pack update for an operating system installed on hosts connected to the storage system. An administrator may send the server a list of hosts that are to receive the update. The server can then perform the operations above for each of the hosts to move the update into encrypted LUNs associated with each of the hosts. For example, the server can obtain the encryption keys for each of the hosts and then create encrypted versions of the update with each of the encryption keys.

FIG. 5 depicts a flow chart with example operations for managing offloaded encryption operations to control load of a storage system. The operations described in FIG. 5 are described as being performed by an encryption server, such as the encryption server 115 or the encryption server 315 depicted in FIGS. 1 and 3 but may be performed by a similar component or device in communication with or located within a storage system.

At block 502, an encryption server (“server”) receives an encryption operation to be performed. The encryption operation may be the encryption of a LUN or the insertion of an unencrypted file into an encrypted LUN. In response to receiving the encryption operation, the server begins reading unencrypted data associated with the encryption operation, encrypting the data, and writing the data to a storage location indicated by the encryption operation. The server sends commands to one or more storage controllers to facilitate the reading and writing of the data. For example, the server may send a command to a first storage controller to read the unencrypted data and send commands to write encrypted data to a second storage controller.

At block 504, the server monitors the load of the storage controller(s) utilized for the encryption operation. Performing the encryption operation leads to an increase in read and write commands for the one or more utilized storage controllers. This increased load can affect the performance of the storage controller and thereby affect the performance of hosts connected to the storage controller. If the server is locally connected to the storage system, the server can retrieve performance metrics for the storage controller from performance monitoring agents executing on the storage system. The performance metrics may include the number of pending read and write operations, average response time, processor load, etc. If the server is unable to retrieve performance metrics, the server may calculate an average response time of the storage controller based on the responses to the server's read or write operations.

At block 506, the server determines whether the performance the storage controllers satisfies a threshold x. The threshold is a configured value corresponding to a performance metric such as an average response time, number pending requests, processor load, etc. The threshold is set to an expected or acceptable value of a performance metric. If a performance metric of the storage controller exceeds or falls below the threshold, the storage controller is considered to be underperforming or encountering degraded performance. The server may compare the performance metrics of the storage controller to the threshold x or a number of thresholds to determine whether the storage controller's metrics satisfy or fall within the thresholds that indicate adequate storage controller performance. If the storage controller satisfies the threshold x, the server determines that the storage controller is performing adequately and control flows to block 504. If the storage controller does not satisfy the threshold x, the server determines that the storage controller is underperforming and control flows to block 508.

At block 508, the server determines if there is another storage controller that satisfies the threshold x. The storage system may include more than one storage controller to provide access to data storage. If the storage system includes additional storage controllers, the server retrieves performance metrics for the storage controllers and determines whether a storage controller satisfies the threshold x. In some implementations, the server may compare the other storage controller metrics to more stringent thresholds to account for the fact that the storage controller may not be currently experiencing increased load caused by the encryption operation. If another storage controller satisfies the threshold x, control then flows to block 514. If another storage controller does not satisfy the threshold x, control then flows to block 516.

At block 510, the server throttles the encryption operation to reduce the storage controller load and satisfy the threshold x. The server throttles the encryption operation by reducing the number of generated read and write requests. The server may reduce the requests by increasing the time between requests or by waiting for a request to respond prior to sending another request. Additionally, the server may decrease requests until the number of pending requests falls below a threshold. Alternatively, the server may halt requests until the storage controller's performance improves. Throttling the encryption operation may increase the amount of time taken to perform the operation but will preserve storage controller performance for hosts connected to the storage system. After throttling the encryption operation, control flows to block 504.

Control flows to block 514 if it was determined at block 508 that another storage controller in the storage system satisfies the threshold x. At block 514, the server redirects requests for the encryption operation to the identified storage controller. The server may cancel pending write requests and reissue the write requests to the new storage controller. After redirecting the requests to the new storage controller, control flows to block 504.

Control flows to block 512 after redirecting requests to a new storage controller at block 514 or after determining that the storage controller satisfies the threshold x at block 506. At block 512, the server increases requests for the encryption operation. If the server determines at block 506 or block 508 that a storage controller satisfies the threshold x, the server may increase a number read and write requests generated for the encryption operation in proportion to an amount that the storage controller satisfied the threshold x. For example, if the storage controller's processor load is 50% below the threshold, the server may increase requests by 50%. As an additional example, if the number of pending requests for the storage controller is 100 below the threshold, the server may generate an additional 100 requests. Also, if requests were throttled or halted at block 510, the server may un-throttle the requests or resume the encryption operation once the storage controller's or the new storage controller's performance satisfies the threshold x.

After increasing requests at block 512 or after throttling the encryption operation at block 510, the server continues monitoring performance of the storage controller utilized for the encryption operation. The monitored storage controller may be the originally utilized storage controller, or the new storage controller identified at block 508. The server continues to monitor and adjust the encryption operation until the encryption operation is complete.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 208, 210, and 212 of FIG. 2 can be performed in parallel or concurrently. With respect to FIG. 4, the server may temporarily map an encrypted LUN to itself instead of cloning an encrypted LUN at block 406. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

In the description above, the encryption server is described as interacting with a single storage controller at a time. However, a storage system may include multiple storage controllers, and the server may submit requests to multiple storage controllers in parallel. Additionally, the server may monitor the performance of the storage controllers and load balance requests for encryption operations among the storage controllers. For example, the server may direct requests to a storage controller that has a low number of pending storage requests.

The variations described above do not encompass all possible variations, aspects, or features. Other variations, modifications, additions, and improvements are possible.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

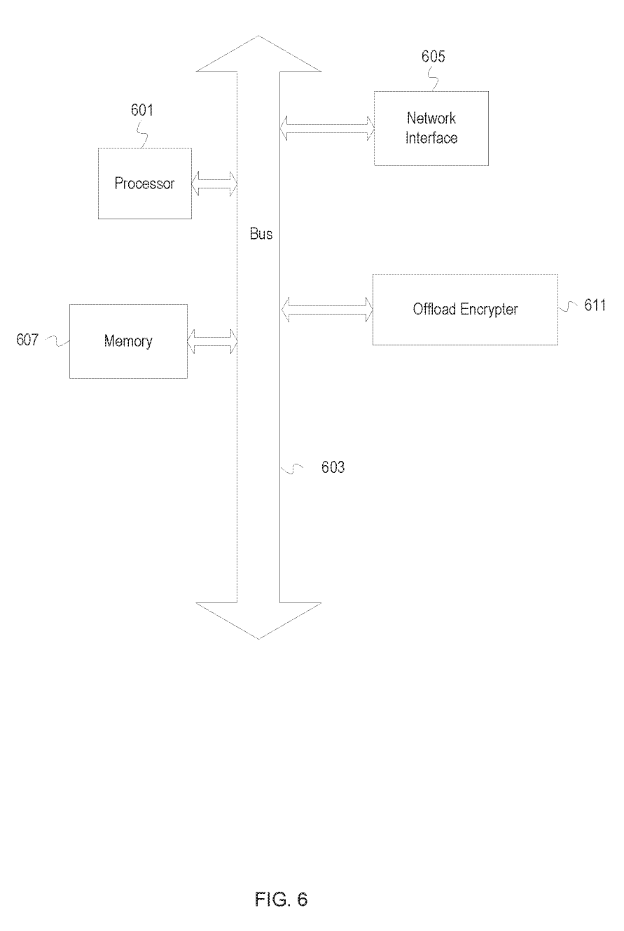

FIG. 6 depicts an example computer system with an offload encrypter. The computer system includes a processor 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes an offload encrypter 611. The offload encrypter 611 performs encryption operations, such as LUN or file encryption, for one or more hosts connected to a storage system. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

While the aspects of the disclosure are described with reference to various implementations and exploitations, it will be understood that these aspects are illustrative and that the scope of the claims is not limited to them. In general, techniques for offloading encryption operations to an encryption server as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
in response to receiving indications of a sparse file stored in an encrypted storage area, an unencrypted data object, and a host,
retrieving an encryption key associated with the host, wherein the encrypted storage area was previously encrypted using the encryption key;
determining block addresses for the sparse file in the encrypted storage area;
retrieving and encrypting the unencrypted data object based, at least in part, on the encryption key;
writing the encrypted data object to the block addresses of the sparse file in a clone of the encrypted storage area; and
moving the encrypted data object from the clone into the encrypted storage area.

2. The method of claim 1, wherein retrieving the encryption key associated with the host comprises:
requesting the encryption key from a device maintaining the encryption key in escrow, wherein the request comprises an identifier for the host and credentials;
wherein the encryption key is provided in response to authentication of the credentials.

3. The method of claim 1, wherein writing the encrypted data object to the block addresses of the sparse file in the clone of the encrypted storage area comprises sending a request to create the clone of the encrypted storage area and map the clone for use.

4. The method of claim 1 further comprising, in response to determining that the encrypted data object has been moved into the encrypted storage area, sending a request to remove the clone.

5. The method of claim 1, wherein writing the encrypted data object to the block addresses of the sparse file in the clone of the encrypted storage area comprises sending write requests for the encrypted data object to a storage controller associated with the encrypted storage area.

6. The method of claim 5 further comprising:
monitoring performance of the storage controller;
determining that the performance of the storage controller does not satisfy a threshold; and
in response to determining that the performance of the storage controller does not satisfy a threshold, reducing a frequency with which the write requests are sent to the storage controller.

7. The method of claim 1, wherein moving the encrypted data object from the clone into the encrypted storage area comprises sending a representation of the encrypted data object to the host.

8. One or more non-transitory machine-readable storage media having program code for storing an unencrypted data object in an encrypted storage area stored therein, the program code to:
in response to indication of a sparse file stored in the encrypted storage area, the unencrypted data object, and a host,
retrieve an encryption key associated with the host, wherein the encrypted storage area was previously encrypted using the encryption key;
determine block addresses for the sparse file in the encrypted storage area;
retrieve and encrypt the unencrypted data object based, at least in part, on the encryption key;
write the encrypted data object to the block addresses of the sparse file in a clone of the encrypted storage area; and
move the encrypted data object from the clone into the encrypted storage area.

9. The machine-readable storage media of claim 8, wherein the program code to retrieve the encryption key associated with the host comprises program code to:
request the encryption key from a device maintaining the encryption key in escrow, wherein the request comprises an identifier for the host and credentials;
wherein the encryption key is provided in response to authentication of the credentials.

10. The machine-readable storage media of claim 8, wherein the program code to move the encrypted data object from the clone into the encrypted storage area comprises program code to send a representation of the encrypted data object to the host.

11. The machine-readable storage media of claim 8 further comprising program code to, in response to a determination that the encrypted data object has been moved into the encrypted storage area, send a request to remove the clone.

12. The machine-readable storage media of claim 8, wherein the program code to write the encrypted data object to the block addresses of the sparse file in the clone of the encrypted storage area comprises program code to send write requests for the encrypted data object to a storage controller associated with the encrypted storage area.

13. The machine-readable storage media of claim 12 further comprising program code to:
monitor performance of the storage controller;
determine whether the performance of the storage controller does satisfies a threshold; and
in response to a determination that the performance of the storage controller does not satisfy a threshold, reduce a frequency with which the write requests are sent to the storage controller.

14. An apparatus comprising:
a processor; and
a machine-readable medium having program code executable by the processor to cause the apparatus to,
in response to indication of a sparse file stored in an encrypted storage area, an unencrypted data object, and a host,
retrieve an encryption key associated with the host, wherein the encrypted storage area was previously encrypted using the encryption key;
determine block addresses for the sparse file in the encrypted storage area;
retrieve and encrypt the unencrypted data object based, at least in part, on the encryption key;
write the encrypted data object to the block addresses of the sparse file in a clone of the encrypted storage area; and
move the encrypted data object from the clone into the encrypted storage area.

15. The apparatus of claim 14, wherein the program code executable by the processor to cause the apparatus to retrieve the encryption key associated with the host comprises program code executable by the processor to cause the apparatus to:
request the encryption key from a device maintaining the encryption key in escrow, wherein the request comprises an identifier for the host and credentials;
wherein the encryption key is provided in response to authentication of the credentials.

16. The apparatus of claim 14, wherein the program code executable by the processor to cause the apparatus to write the encrypted data object to the block addresses of the sparse file in the clone of the encrypted storage area comprises program code executable by the processor to cause the apparatus to send a request to create the clone of the encrypted storage area and map the clone for use.

17. The apparatus of claim 14, wherein the program code executable by the processor to cause the apparatus to move the encrypted data object from the clone into the encrypted storage area comprises program code executable by the processor to cause the apparatus to send a representation of the encrypted data object to the host.

18. The apparatus of claim 14 further comprising program code executable by the processor to cause the apparatus to, in response to a determination that the encrypted data object has been moved into the encrypted storage area, send a request to remove the clone.

19. The apparatus of claim 14, wherein the program code executable by the processor to cause the apparatus to write the encrypted data object to the block addresses of the sparse file in the clone of the encrypted storage area comprises program code executable by the processor to cause the apparatus to send write requests for the encrypted data object to a storage controller associated with the encrypted storage area.

20. The apparatus of claim 19 further comprising program code executable by the processor to cause the apparatus to:
monitor performance of the storage controller;
determine whether the performance of the storage controller does satisfies a threshold; and
in response to a determination that the performance of the storage controller does not satisfy a threshold, reduce a frequency with which the write requests are sent to the storage controller.
